(19) United States
(12) Patent Application Publication
(10) Pub. No.: US 2025/0296119 A1
(43) Pub. Date: Sep. 25, 2025

(54) ROLL FORMER TENDING AUTOMATION DEVICES, SYSTEMS, AND METHODS

(71) Applicant: MiddleGround Capital, LP, Lexington, KY (US)

(72) Inventors: Miles Anderson, Georgetown, KY (US); Jeremy Beals, Georgetown, KY (US); Jonathan Hatter, Georgetown, KY (US); Scottie Foster, Lawrenceburg, KY (US); John Hutchinson, Georgetown, KY (US); Rodney Roark, Georgetown, KY (US); Donnie Christian, Sadieville, KY (US); Bobby Parks, Richmond, KY (US); John Dotson, Georgetown, KY (US)

(73) Assignee: MiddleGround Capital, LP, Lexington, KY (US)

(21) Appl. No.: 19/085,279

(22) Filed: Mar. 20, 2025

Related U.S. Application Data
(60) Provisional application No. 63/568,153, filed on Mar. 21, 2024.

(51) Int. Cl. B07C 5/36; B65G 47/82

(52) U.S. Cl. CPC B07C 5/36; B65G 47/82

(57) ABSTRACT

A system for sorting a plurality of preformed articles may include a sorting assembly with a base, a conveyor for transporting preformed articles to a sorting assembly and a drive assembly positioned between the sorting assembly and the conveyor. The sorting assembly may shift the base along the horizontal axis, the vertical axis or along both the horizontal and vertical axis to align one preformed article with another preformed article. Methods of operating a system for sorting a plurality of preformed articles are also contemplated.

### CROSS REFERENCE TO RELATED APPLICATIONS

This application claims the benefit of U.S. Provisional Patent Application Ser. No. 63/568,153 filed Mar. 21, 2024, the disclosure of which is incorporated herein by reference.

### TECHNICAL FIELD

The present disclosure pertains to roll former tending automation devices, systems, and methods. More specifically, the present disclosure relates to the automated sorting of preformed articles for efficient collecting, sorting and delivery of preformed articles.

### BACKGROUND

A variety of automated roll former tending systems may be used for sorting articles of manufacture. For example, an automated roll former tending system may be used to sort multiple pieces of stock (e.g., bar stock, flat stock, angled stock, cylindrical stock, square stock, hexagonal stock, channel stock, tubing, pipe, etc.). Some of these devices and systems may include processing logic, drive motors, sensors, conveyors and assemblies for receiving and transporting articles of manufacture. Of the known automated roll former tending devices, systems, and methods, each has certain advantages and disadvantages. There is an ongoing and unmet need to provide alternative automated roll former tending devices and systems as well as alternative methods for operating and utilizing automated roll former tending systems.

### BRIEF SUMMARY

This disclosure provides design, material, methods, and use alternatives for automated roll former tending systems, devices and methods.

In a first example, a system for sorting a plurality of preformed articles is disclosed. The system includes a sorting assembly which includes a base. The base of the sorting assembly further includes a first end region, a second end region, a horizontal axis and a vertical axis. The system of the present disclosure may further include a conveyor which transports a first preformed article and a second preformed article toward the sorting assembly. The system may further include a drive assembly positioned between the sorting assembly and the conveyor, in which the drive assembly may receive the first preformed article and the second preformed article from the conveyor and transport both the first preformed article and the second preformed article from the conveyor and onto the base. The sorting assembly may also shift the base along the horizontal axis, the vertical axis or in both the horizontal and the vertical axis to align the first preformed article with the second preformed article.

Alternatively or additionally to any of the examples above, the drive assembly may sequentially receive the first preformed article and the second preformed article from the conveyor and transport both the first preformed article and the second preformed article from the conveyor onto the base.

Alternatively or additionally to any of the examples above, the drive assembly may further include a first wheel, a second wheel and a drive motor operatively coupled to the first wheel. The first wheel and the second wheel may also receive and transport the first preformed article and the second preformed article onto the base.

Alternatively or additionally to any of the examples above, the base may also include one or more alignment regions positioned between the first end region of the base and the second end region of the base.

Alternatively or additionally to any of the examples above, the sorting assembly may further include a kickplate positioned adjacent the first end region of the base. The kickplate may also shift between a first retracted position and a second extended position.

Alternatively or additionally to any of the examples above, the sorting assembly may further include a first alignment motor to shift the base along the horizontal axis.

Alternatively or additionally to any of the examples above, the sorting assembly may further include a second alignment motor to shift the base along the vertical axis.

Alternatively or additionally to any of the examples above, the sorting assembly may further include a sensor positioned adjacent the kickplate. The sensor may also sense the first preformed article, the second preformed article or both the first and the second preformed article.

Alternatively or additionally to any of the examples above, the sensor may also signal the kickplate to shift between the first retracted position and the second extended position.

Alternatively or additionally to any of the examples above, the kickplate may also engage the first preformed article, the second preformed article or both the first and the second preformed articles when shifting from the first retracted position to the second extended position.

Alternatively or additionally to any of the examples above, the first preformed article may also include a first end and the second preformed article may also include a first end. In this example and others, the kickplate may also align the first end of the preformed article with the first end of the second preformed article.

Alternatively or additionally to any of the examples above, the one or more alignment members may also include a first alignment member adapted to accept the first preformed article.

Alternatively or additionally to any of the examples above, the one or more alignment members may also include a peaked profile.

Alternatively or additionally to any of the examples above, the drive assembly may also include a sensor configured to sense a first end of the first preformed article, a second end of the first preformed article or both the first end and the second end of the first preformed article.

Alternatively or additionally to any of the examples above, the conveyor may also include a conveyor sensor positioned adjacent to the conveyor, and the conveyor sensor may sense a first end of the first preformed article, a second end of the first preformed article or both the first end and the second end of the first preformed article.

In another example, a system for sorting a plurality of preformed articles is provided. The system includes a sorting assembly. The sorting assembly may include a base, the base having a first end region, a second end region, a horizontal axis and a vertical axis. The base may also include one or more alignment regions positioned between the first end region of the base and the second end region of the base. The system of the present disclosure may also include a conveyor. The conveyor may transport a first preformed article and a second preformed article toward the sorting assembly. The system of the present disclosure may also include a drive assembly positioned between the sorting assembly and the conveyor, the drive assembly may receive the first preformed article and the second preformed article from the conveyor and transport them from the conveyor to the base. The sorting assembly may also shift the base along the horizontal axis, the vertical axis or along both the horizontal axis and the vertical axis to align the first preformed article with the second preformed article along the one or more alignment regions.

Alternatively or additionally to any of the examples above, the one or more alignment regions may include one or more alignment members. The one or more alignment regions may also receive and align at least the first preformed article, the second preformed article and a third preformed article of preformed material.

Alternatively or additionally to any of the examples above, the sorting assembly may further include a kickplate positioned adjacent the first end region of the base. The kickplate may also include a plurality of sensors and may shift between a first retracted position and a second extended position.

In further examples, a method for sorting a plurality of preformed articles is contemplated. The method may include transporting a first preformed article and a second preformed article via a conveyor. The conveyor may be operatively connected to a drive assembly. Next, a receiving step is contemplated where the first preformed article and the second preformed article are received into the drive assembly from the conveyor. After that, a transporting step is contemplated in which the first preformed article and the second preformed article are transported to a sorting assembly operatively connected to the drive assembly and via the drive assembly. The sorting assembly may include a base, a horizontal axis and a vertical axis. Next, a shifting step is contemplated. The shifting step includes shifting the base along the vertical axis, the horizontal axis or along both the horizontal axis and the vertical axis to align the first preformed article with the second preformed article.

The above summary of some embodiments is not intended to describe each disclosed embodiment or every implementation of the present disclosure. The Figures, and Detailed Description, which follow, more particularly exemplify some of these embodiments.

### BRIEF DESCRIPTION OF THE DRAWINGS

The disclosure may be more completely understood in consideration of the following detailed description in connection with the accompanying drawings, in which:

FIG. 1 shows a front view of an example automated roll former tending system of the present disclosure;

FIG. 2 shows a perspective view of an example automated roll former tending system of the present disclosure;

FIG. 3 shows an example drive assembly positioned between a conveyor and a sorting assembly of the present disclosure;

FIG. 4 shows a preformed article passing through the drive assembly shown in FIG. 3;

FIG. 5 shows an example sorting assembly of the present disclosure;

FIG. 6 shows an example kickplate assembly of the present disclosure in a first configuration;

FIG. 7 shows an example kickplate assembly of the present disclosure in a second configuration;

FIG. 8 shows a top view of an example drive assembly and alignment regions of the present disclosure;

FIG. 9 shows an example kickplate assembly of the present disclosure in a first configuration;

FIG. 10 shows an example kickplate assembly of the present disclosure in a second configuration;

FIG. 11 shows an example kickplate assembly of the present disclosure in a first configuration;

FIG. 12 shows a preformed article passing through an example drive assembly and on to a previously-positioned preformed article.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “a configuration”, “another configuration”, “some configurations”, “other configurations”, etc., indicate that the configuration described may include one or more particular features, structures, and/or characteristics. However, such recitations do not necessarily mean that all embodiments include the particular features, structures, and/or characteristics. Additionally, when particular features, structures, and/or characteristics are described in connection with one configuration, it should be understood that such features, structures, and/or characteristics may also be used in connection with other configurations whether or not explicitly described unless clearly stated to the contrary.

The following detailed description should be read with reference to the drawings in which similar structures in different drawings are numbered the same. The drawings, which are not necessarily to scale, depict illustrative embodiments and are not intended to limit the scope of the disclosure. Additionally, it should be noted that in any given figure, some features may not be shown, or may be shown schematically, for clarity and/or simplicity. Additional details regarding some components and/or method steps may be illustrated in other figures in greater detail. The devices and/or methods disclosed herein may provide a number of desirable features and benefits as described in more detail below.

A variety of automated roll former tending devices and systems are known for boosting the efficiency of production lines by collecting and sorting manufactured articles. Such manufactured articles may be composed of steel, iron, alloys, wood, plastics, polymers, composite materials, any combination of the aforementioned, or the equivalent or the like. Additionally, the sorting and collection of specified manufactured components is another function of most automated roll former tending systems. Manufactured components may include but are not limited to dry wall, steel beams, wooden beams, sheet metal, bar stock, iron bar, rebar, plasticized items, polymerized items, or any manufactured article. Additionally or alternatively, automated roll former tending devices and systems may include processing logic, AI capability, sensors, motors, conveyors, and like components. Additionally, an unmet need exists for alternative and more efficient means for collecting and sorting manufactured articles. The present disclosure depicts and illustrates advantages over the prior art.

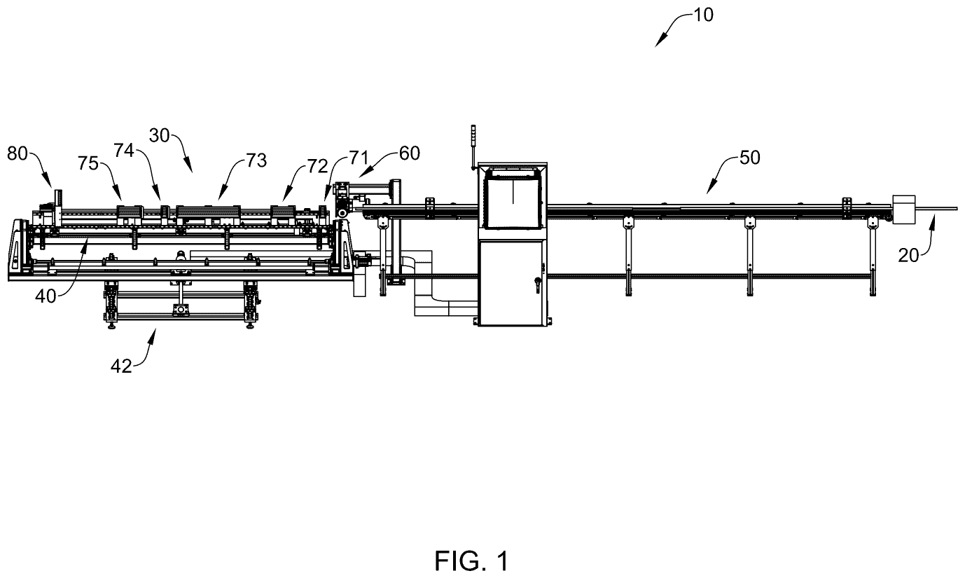

FIG. 1 depicts an illustrative automated roll former system 10 configured to collect and sort manufactured or preformed articles. The system 10 may include a sorting assembly 30, a sorting assembly base 40 coupled to a support frame 42, a conveyor 50, a drive assembly 60, alignment regions 71, 72, 73, 74, 75 disposed along the sorting assembly base 40, and a kickplate assembly 80. FIG. 1 further illustrates a preformed article 20 positioned along the conveyor 50.

In some examples, the preformed article 20 may be any preformed article known in the art. Such preformed articles include but are not limited to rebar, stock (e.g., bar stock, flat stock, angled stock, cylindrical stock, square stock, hexagonal stock, channel stock, etc.), aluminum posts, aluminum beams, aluminum bars, plastic posts, plastic beams, plastic bars, steel posts, steel beams, steel bars, alloyed posts, alloyed beams, alloyed bars, wooden beams, wooden posts, wooden bars, composite posts, composite beams, composite bars, drywall, pylons of any material, bars of any material, material of any geometric shape, or any equivalent manufactured or preformed article known in the art.

In this and other examples, the preformed article 20 may be fed onto a conveyor 50 which transports the preformed article 20 toward the drive assembly 60. The drive assembly 60 may receive the preformed article 20 and thereafter transport the preformed article 20 to the sorting assembly 30.

The preformed article 20 and any plurality of preformed articles 20 may be delivered simultaneously or sequentially to the conveyor 50 from any of a variety of known feeding systems. For example, the preformed article 20 and any plurality of preformed articles 20 may be fed onto the conveyor 50 via a pneumatic drive assembly, a rotational drive assembly, a pump assembly, a sliding drive assembly, a motored assembly, loaded by the user, loaded by a robot, loaded by a mechanical drive mechanism, or any drive mechanism or means known in the art for feeding preformed articles or material onto the conveyor 50.

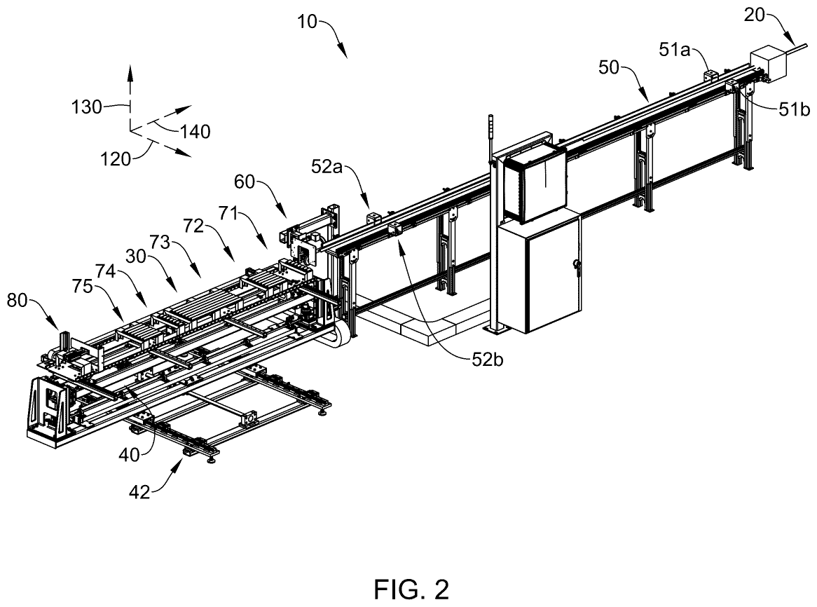

The sorting assembly 30 may include a base 40 which may shift along its horizontal axis 120 (see FIG. 2), its vertical axis 130 (see FIG. 2), or both along its horizontal axis 120 and the vertical axis 130. FIG. 1 further illustrates that the sorting assembly 30 may also include one or more alignment regions 71, 72, 73, 74, 75. The alignment regions 71, 72, 73, 74, 75 may direct (e.g., align) a preformed article 20 along a preferred path (e.g., direction, track, etc.) as it translates along the base 40. In other words, during operation of the system 10, a preformed article 20 may be transported along the conveyor 50 toward the drive assembly 60, then transported through the drive assembly 60 onto the sorting assembly 30, whereby the preformed article 20 may be slidably nested along one or more of the alignment regions 71, 72, 73, 74, 75 as the preformed article 20 travels to a position adjacent the kickplate assembly 80.

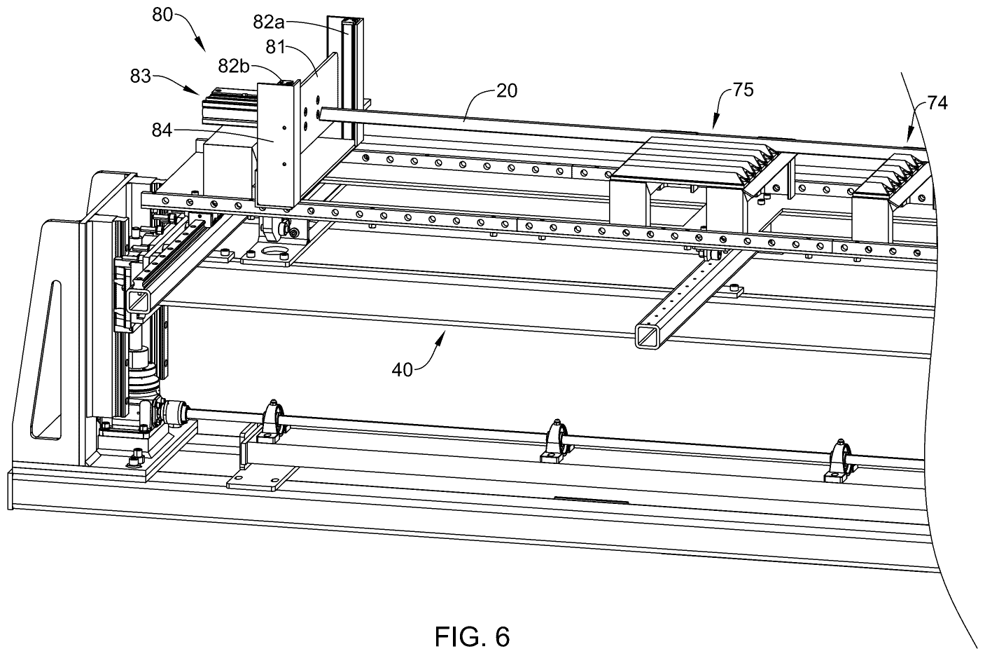

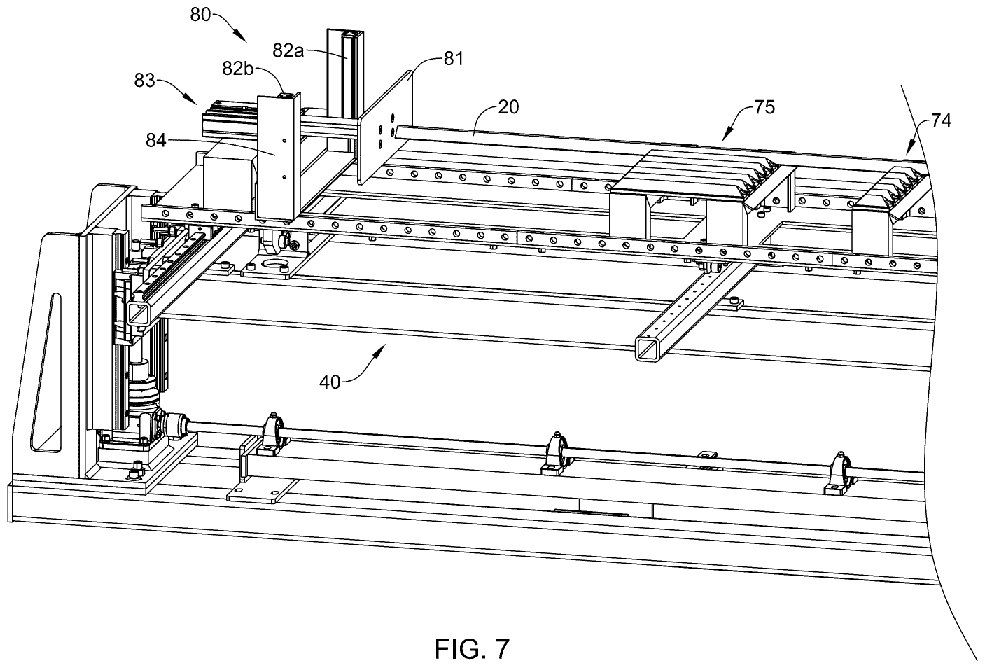

The kickplate assembly 80 of FIG. 1 may be configured to longitudinally position (e.g., align) one or more preformed articles along the base 40 of the support assembly 30. The kickplate assembly 80 may act to extend a kickplate 81 (see FIG. 7) from a first resting position (see FIG. 6) to a second extended position (see FIG. 7) whereby the kickplate 81 may engage (e.g., abut) a preformed article 20, thus moving the preformed article 20 into a desired longitudinal alignment along the one or more alignment regions 71, 72, 73, 74, 75 of the sorting assembly 30.

FIG. 2 illustrates a perspective view of the example system 10 of the present disclosure. As shown, a preformed article 20 may be fed onto a conveyor 50 that may be equipped with at least one or more conveyor sensors 51a, 51b. In some examples, the sensors 51a, 51b may be operably coupled to one another and together form a set of sensors 51a, 51b. The conveyor sensors 51a, 51b may sense the presence of a preformed article 20 in any manner such as sensing the front end of the preformed article 20, the back end of the preformed article 20, the midpoint of the preformed article 20, or any desired point along the preformed article 20. Any sensor or plurality of sensors known in the art may be incorporated as a conveyor sensor 51a, 51b. Sensors include but are not limited to position sensors, velocity sensors, acceleration sensors, jerk sensors, optical sensors, electric sensors, photoelectric sensors, infrared sensors, ultraviolet sensors, frequency sensors, force sensors, pressure sensors, or any of the equivalent or the like. In this and other examples, one or more of the conveyor sensors 51a, 51b may sense the presence of a preformed article 20 and send a signal to the conveyor 50 to continue to transport, stop transport or delay transport given the information obtained by one or more of the conveyor sensors 51a, 51b. In other examples, the system may include a second set of sensors 52a, 52b positioned closer to the drive assembly 60 relative to the sensors 51a, 51b. The second set of sensors 52a, 52b may be configured to sense the presence of a preformed article 20 in any manner such as sensing the front end of the preformed article 20, the back end of the preformed article 20, the midpoint of the preformed article 20, or any desired point along the preformed article 20.

Additionally or alternatively, the conveyor sensors 51a, 51b of conveyor 50 may sense the presence of a plurality of preformed articles 20 in any manner such as sensing the front end the plurality of preformed articles 20, the back end of the plurality of preformed articles 20, the midpoint of the plurality of preformed articles 20, or any desired point along the plurality of preformed articles 20.

In this and other examples, if any of the one or plurality of preformed articles 20 is out of desired positioning, one or more of the conveyor sensors 51a, 51b, 52a, 52b may signal the conveyor 50 to halt movement, reverse movement, speed up movement forward, speed up movement backward, slow down movement forward, slow down movement backward or momentarily pause or postpone movement and/or operation of the conveyor 50.

Additionally, the preformed article 20 may be transported along the conveyor 50 and toward a drive assembly 60. The drive assembly 60 may receive the preformed article 20 and thereafter transport the preformed article 20 onto the base 40 of the sorting assembly 30. In some examples, the drive assembly 60 may include a plurality of drive assembly sensors affixed to the drive assembly 60, affixed adjacent to the drive assembly 60 or affixed near the drive assembly 60 or affixed to a structure adjacent or near the drive assembly 60. Such structures adjacent or near the drive assembly 60 may include but are not limited to: one or more brackets, one or more C-shaped brackets, one or more L-shaped brackets, one or more I-shaped brackets, one or more T-shaped brackets, one or more housings, one or more tubular structures, one or more cubic structures, one or more oblong structures, one or more ellipsoidal structures, one or more spherical structures, or any known housing structure in the art. Further, the plurality of drive assembly sensors may be affixed remote from the drive assembly 60, and may further be connected via WI-FI, Bluetooth, wired connection, electromagnetic connection, magnetic connection, or any other tethering connection known in the art.

The aforementioned drive assembly sensors may sense the presence of a preformed article 20 or any plurality of preformed articles 20 as they approach and pass through the drive assembly 60. The aforementioned drive assembly sensors may also detect the front end of the preformed article, the back end of the preformed article 20, the midpoint of the preformed article 20 or any desired point along the preformed article 20 or plurality of preformed articles 20 and send signals to the drive assembly 60 regarding the positioning of the preformed article 20. If the preformed article 20 is out of desired positioning, the aforementioned drive assembly sensors may signal the drive assembly 60 to stop, reverse, forward, speed up, slow down, pause momentarily, or postpone transportation of the preformed article 20. Any sensor or plurality of sensors known in the art may be incorporated as a drive assembly sensor or plurality of drive assembly sensors. Such sensors include but are not limited to position sensors, velocity sensors, acceleration sensors, jerk sensors, optical sensors, electric sensors, photoelectric sensors, infrared sensors, ultraviolet sensors, frequency sensors, force sensors, pressure sensors, or any of the equivalent or the like.

Further, FIG. 2 illustrates the system 10 may include a plurality of alignment regions 71, 72, 73, 74, 75 disposed along the base 40 of the sorting assembly 30. As will be discussed in greater detail below, each of the alignment regions 71, 72, 73, 74, 75 may include one or more alignment members configured to position (e.g., align, direct, track, sort, etc.) one or more preformed articles 20 along the alignment regions 71, 72, 73, 74, 75. In other words, as a preformed article 20 moves along the base 40, the preformed article 20 may engage (e.g., slide along, nest upon, nest along, rest upon, etc.) the an alignment member of the one or more alignment regions 71, 72, 73, 74, 75.

The base 40 of sorting assembly 30 may be configured to shift along its horizontal axis 120, its vertical axis 130 or both along its horizontal axis 120 and vertical axis 130 to aid in aligning one or more preformed articles 20 along the alignment regions 71, 72, 73, 74, 75. The base 40 may further be adapted to shift along its horizontal axis 120, its vertical axis 130 or both along its horizontal axis 120 and vertical axis 130 to aid in aligning a plurality of preformed articles 20 along the alignment regions 71, 72, 73, 74, 75.

FIG. 2 further illustrates that the kickplate assembly 80 may be positioned at an end region of the system 10 opposite the conveyor 50. The kickplate assembly 80 may be configured longitudinally align the one or more preformed articles 20 along the base 40.

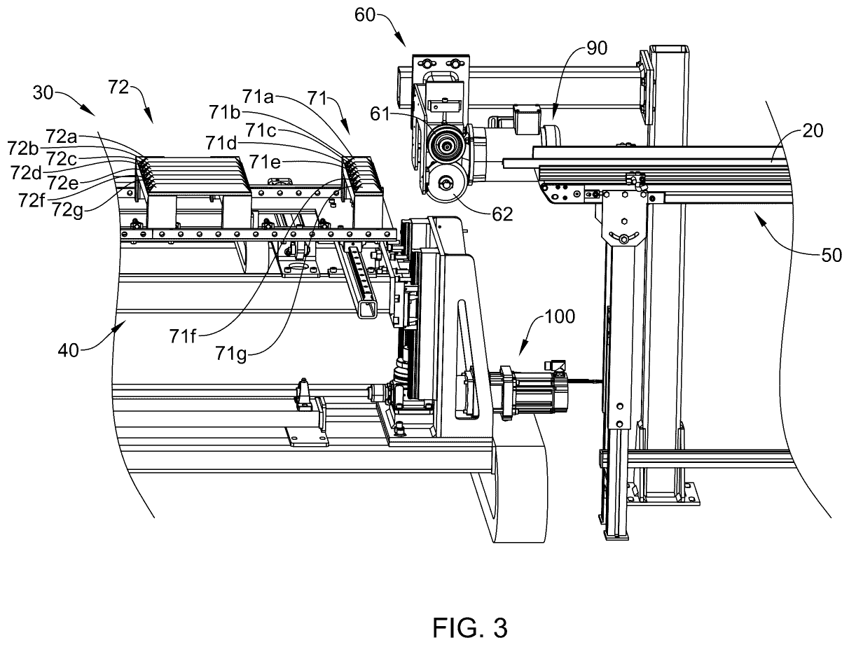

FIG. 3 depicts a detailed view of an example drive assembly 60 of the system 10. Drive assembly 60 may include an upper wheel 61 and a lower wheel 62 which may be operably coupled to a drive assembly motor 90. The drive assembly motor 90 may supply power to the upper wheel 61, the lower wheel 62, or both the upper wheel 61 and the lower wheel 62 to rotate (e.g., drive) the upper wheel 61, the lower wheel 62, or both the upper wheel 61 and the lower wheel 62. The rotation of the upper wheel 61, lower wheel 62, or both the upper wheel 61 and the lower wheel 62 may allow the upper wheel 61, the lower wheel 62, or both the upper wheel 61 and the lower wheel 62 to receive one or more preformed articles 20 and transport the preformed articles 20 toward the alignment regions 71, 72, 73, 74, 75 positioned along the base 40 of the support assembly 30.

The upper wheel 61 and the lower wheel 62 may rotate forward or backward. Further, the upper wheel 61 and the lower wheel 62 may rotate counter to one another. Alternatively or additionally, the upper wheel 61 and lower wheel 62 may spin at different speeds and/or RPMs from each other. In other examples, the drive assembly 60 may include multiple upper wheels and multiple lower wheels. In further examples, only an upper wheel is contemplated. In other words, in this and other examples the drive assembly 60 may include one wheel. In other examples, the drive assembly 60 may include two wheels. In yet other examples, the drive assembly 60 may include three wheels, four wheels, five wheels, six wheels, seven wheels, eight wheels, nine wheels, ten wheels, eleven wheels or twelve or more wheels. In further examples, the drive assembly 60 may include two upper wheels and one lower wheel, two lower wheels and one upper wheel, three upper wheels and two lower wheels, three lower wheels and two upper wheels, three upper wheels and three lower wheels, four upper wheels and three lower wheels, four lower wheels and three upper wheels, four upper wheels and four lower wheels, or any combination or permutation of the aforementioned including the additional incorporation of added upper and/or lower wheels. Further, additional wheels may be placed adjacent to the upper and/or lower wheel and/or upper wheels and/or lower wheels. In other words, a side wheel may be incorporated adjacent to one or more lower wheels, one or more upper wheels, or adjacent to both one or more upper and lower wheels. Also, a plurality of side wheels may be incorporated adjacent to one or more lower wheels, one or more upper wheels, or adjacent to both one or more upper and lower wheels.

In further examples, the drive assembly 60 may utilize components in lieu of wheels. Other components contemplated by the present disclosure include, but are not limited to, pneumatic actuators, electronic actuators, piezoelectric actuators, sliding members, spinning members, discs, finger projections, projecting members, concave members, convex members, irregularly shaped members, vacuum pumps, suction pumps, displacement pumps, valved pumps or any equivalent component known in the art. These alternative components may be present singularly, or in a plurality, or in any combination or permutation known in the art.

As will be discussed in greater detail herein, FIG. 3 further illustrates an example vertical alignment motor 100 of the present disclosure. The vertical alignment motor 100 may act upon the base 40 of the sorting assembly 30 to shift the base 40 vertically (i.e., raise or lower the base 40 along its vertical axis 130) to align one or more preformed articles 20 along the alignment regions 71, 72, 73, 74, 75. It can be appreciated that shifting the base 40 vertically may permit stacking of a plurality preformed articles 20 in a vertical arrangement along the base 40. In other words, it can be appreciated that shifting the base 40 vertically may permit vertical stacking of a multiple layers of preformed articles 20 on top of one another along the base 40.

Examples of vertical alignment motors that are contemplated by the present disclosure include, but are not limited to: servo motors, stator motors, DC motors, brushless DC motors, AC motors, AC/DC motors, gas motors, electric motors, solar-powered motors, synchronous motors, asynchronous motors, stepper motors, induction motors, commutator motors, direct drive motors or any equivalent known in the art.

As shown in at least FIG. 3, the alignment region 71 may include one or more individual alignment members 71a-g and the alignment region 72 may include one or more individual alignment members 72a-g. As illustrated in FIG. 3, any of the alignment members of the present disclosure may have a peaked profile. In other words, the alignment members may be formed such that their structure has at least one of an apex and one of a valley. For instance, the alignment members of the present disclosure may be V-shaped, convex, concave, jagged, undulating, I-shaped, T-shaped, L-shaped, W-shaped, pyramidal, prismatic, or any other shape or form known in the art.

Additionally, it can be appreciated that the alignment members of adjacent alignment regions may be aligned with one another along the longitudinal axis 140 (see FIG. 2) of the base 40. For example, FIG. 3 illustrates that the alignment member 71a of the alignment region 71 may be longitudinally aligned with the alignment member 72a of the alignment region 72, the alignment member 71b of the alignment region 71 may be longitudinally aligned with the alignment member 72b of the alignment region 72, the alignment member 71c of the alignment region 71 may be longitudinally aligned with the alignment member 72c of the alignment region 72, the alignment member 71d of the alignment region 71 may be longitudinally aligned with the alignment member 72d of the alignment region 72, the alignment member 71e of the alignment region 71 may be longitudinally aligned with the alignment member 72e of the alignment region 72, the alignment member 71f of the alignment region 71 may be longitudinally aligned with the alignment member 72f of the alignment region 72 and the alignment member 71g of the alignment region 71 may be longitudinally aligned with the alignment member 72g of the alignment region 72. It can be further appreciated that an alignment member of a given alignment region 71, 72, 73, 74, 75 may be longitudinally aligned with a respective alignment member of an adjacent alignment region 71, 72, 73, 74, 75 along the base 40 of the sorting assembly 30.

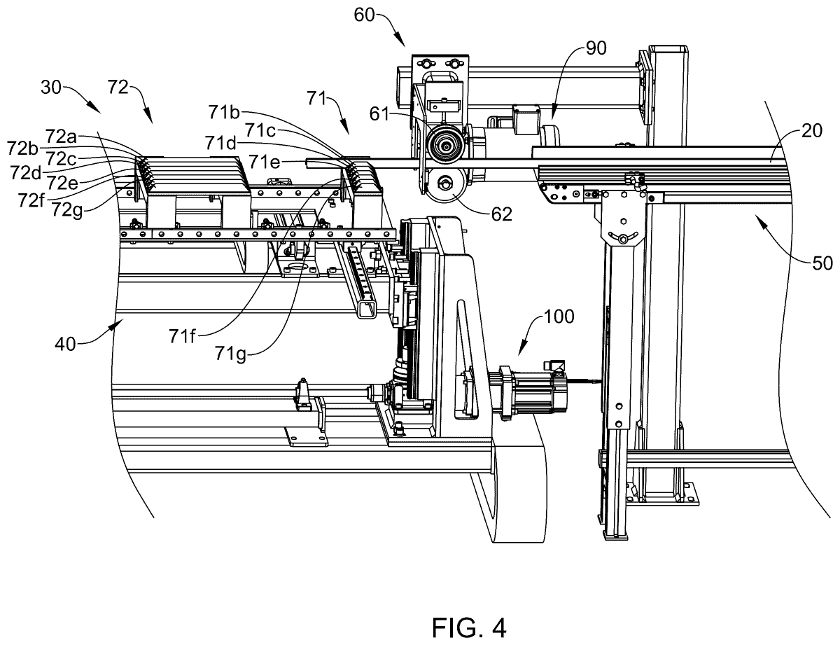

FIG. 4 illustrates the drive assembly 60 transporting the preformed article 20 from the conveyor 50 to the sorting assembly 30 by passing the preformed article 20 between the upper wheel 61 and the lower wheel 62 of the drive assembly 60, driven in part by the drive assembly motor 90. Further, the preformed article 20 may be guided by the drive assembly 60 onto an alignment member 71a (see FIG. 3) of the alignment region 71. From there, the preformed article 20 may be driven further down the base 40 and onto the alignment members 72a of the alignment region 72 while a portion of the preformed article 20 remains resting on the alignment member 71a. For instance, as preformed article 20 is driven into nesting alignment along alignment member 71a, it may continue into nesting alignment along alignment member 72a, and sequentially progress into nesting alignment along alignment members positioned along alignment regions 73, 74, and 75, respectively. It can be appreciated that this may occur while the preformed article 20 remains aligned on the alignment members that it has previously passed thereupon.

Furthermore, during traversal of the preformed article 20, the preformed article 20 may be guided along a combination of a plurality of longitudinally aligned alignment members. For example, the preformed article 20 may pass through the drive assembly 60 onto sorting assembly 30 and may be nested onto alignment member 71a. As the preformed article 20 travels along the sorting assembly 30, it may slide along alignment member 71a, nest onto alignment member 72a and slides along alignment member 72a towards the kickplate assembly 80 at the end of the system 10. Further, as the preformed article 20 travels toward the kickplate assembly 80, it may further slide along alignment members of the alignment regions 73, 74, 75 which are longitudinally aligned with the alignment members 71a, 72a.

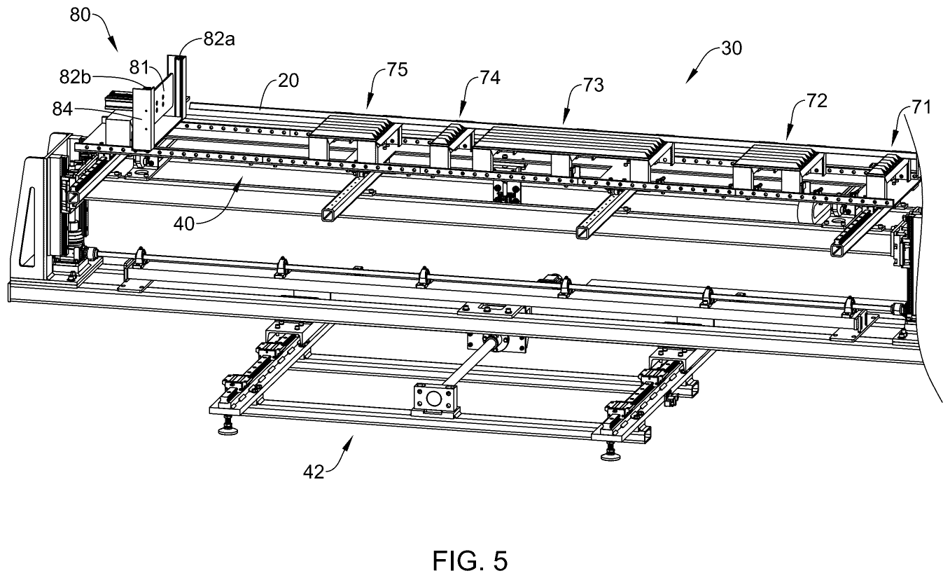

FIG. 5 illustrates the example sorting assembly 30 and kickplate assembly 80 of the present disclosure. As discussed herein, the sorting assembly 30 may include a base 40 and a plurality of alignment regions 71, 72, 73, 74, 75, each of which may include one or more alignment members, respectively. In some examples, additional alignment regions and alignment members are contemplated. In other examples, fewer alignment regions and alignment members are contemplated. For purposes of design efficiency, any number of alignment regions and alignment members may be incorporated.

Additionally, the alignment members of the present disclosure may have a peaked profile. In other words, the alignment members may be formed such that each alignment member includes at least one of an apex and one of a valley. This is not intended to be limiting. Rather, the alignment members of the present disclosure may be V-shaped, convex, concave, jagged, undulating, I-shaped, T-shaped, L-shaped, W-shaped, pyramidal, prismatic, or any other shape or form known in the art.

As discussed herein, as a preformed article 20 passes through the drive assembly 60 and moves along the base 40, the preformed article 20 may slide along a combination of longitudinally aligned alignment members. For instance, if the preformed article 20 is first aligned along alignment member 71a, it may continue moving along the base 40 and slidably nest onto alignment member 72a, continue along the base 40 and slidably nest onto alignment member 73a, then slidably nest onto alignment member 74a, and then slidably nest onto alignment member 75a. The preformed article 20 may remain nested along the alignment members 71a, 72a, 73a, 74a, 74a throughout this process even as the kickplate 81 engages the preformed article 20 and longitudinally aligns the preformed article 20 along the alignment members 71a, 72a, 73a, 74a, 74a of the sorting assembly 30.

Additionally, FIG. 5 illustrates that the kickplate assembly 80 may further include a plurality of kickplate sensors 82a, 82b. Additionally, each of the kickplate sensors 82a, 82b may be vertically aligned and positioned on either side of the kickplate 81. Additionally, as will be discussed in greater detail below, the kickplate sensors 82a, 82b may be spaced on either side of the kickplate 81 such that the kickplate 81 may pass between the kickplate sensor 82a and the kickplate sensor 82b. In some examples, the configuration of the kickplate sensors 82a, 82b may define a sensing “light curtain.” The light curtain may define a beam of light passing between the sensors 82a, 82b, whereby a portion of an object (e.g., preformed article 20) passing through the beam of light triggers the kickplate 81 to extend, engage and/or longitudinally position the preformed articles 20 or other sensed objects along the base 40. The light curtain may conform to the geometry of a bar, a spike, a cube, a sphere, a patterned structure, an intermittent structure, or any geometry or patterned geometry or shape known in the art. Additionally, the kickplate sensors 82a, 82b may be affixed or connected to any part of the kickplate assembly 80.

As discussed herein, the kickplate 81 may engage a preformed article 20 after the preformed article 20 reaches a predetermined position along the base 40. For example, when a preformed article 20 passes between the kickplate sensors 82a, 82b, the kickplate sensors 82a, 82b may sense the preformed article 20 and thereby trigger the kickplate 81 to extend toward and engage the preformed article 20. The kickplate 81 may shift the preformed article 20 along the base 40 from a first position to a second position, whereby the preformed article 20 is positioned in a final longitudinal alignment position. It can be appreciated that the preformed article 20 may be resting (e.g., nested) upon one or more of the alignment members of one or more of the alignment regions 71, 72, 73, 74, 75 as the kickplate 81 engages and shifts the preformed article 20 longitudinally along the base 40.

The kickplate sensors 82a, 82b of the kickplate assembly 80 may be any sensor or a plurality of sensors including but not limited to position sensors, velocity sensors, acceleration sensors, jerk sensors, optical sensors, electric sensors, photoelectric sensors, infrared sensors, ultraviolet sensors, frequency sensors, pressure sensors, or any of the equivalent or the like.

Additionally, in other examples, he kickplate sensors 82a, 82b may be positioned anywhere on the kickplate 81, including on an outer surface of the kickplate 81. Additionally, any kickplate sensor or a plurality of sensors may be embedded within the kickplate 81, affixed to the kickplate 81, affixed adjacent to the kickplate 81, embedded within the kickplate assembly 80, affixed to the kickplate assembly 80, or affixed adjacent to the kickplate assembly 80. Kickplate sensors may be affixed in the geometrical center of the kickplate assembly. Further, kickplate sensors may be affixed at the center of gravity of the kickplate assembly.

In this and other examples, a first preformed article and a second preformed article may be sequentially transported along the conveyor 50, through the drive assembly 60 and onto the sorting assembly 30. As will be described in greater detail herein, a preformed article that passing through the light curtain generated by the kickplate sensors 82a, 82b may cause a signal to be sent to the kickplate 81, whereby the kickplate 81 may extend to engage the first preformed article. The engagement of the kickplate 81 with the end of the first preformed article may align and position the first preformed article along the alignment members of the alignment regions, as described herein.

Further, after the first preformed article is positioned by the kickplate 81, the kickplate 81 may retract from its second extended position back to its home position. After the kickplate 81 retracts, a second preformed article may be transported along the conveyor 50, through the drive assembly 60 and onto the sorting assembly 30. It can be appreciated that a first end of a second preformed article may pass through the light curtain generated by the kickplate sensors 82a, 82b and may cause a signal to be sent to the kickplate 81, whereby the kickplate 81 may extend to engage the second preformed article. The engagement of the kickplate 81 with the first end of the second preformed article may align and position the first end of the second preformed article with the first end of the first preformed article, as described herein.

FIGS. 6-11 illustrate the sequence of steps described herein to align a first end of a first preformed article with a first end of a second preformed article.

FIG. 6 illustrates a first preformed article 20 passing through the light curtain generated by the first kickplate sensor 82a and the second kickplate sensor 82b after having been transported along the conveyor 50, through the drive assembly 60 and onto the sorting assembly 30. As discussed herein, the kickplate 81 illustrated in FIG. 6 has yet to be triggered via the light curtain and remains in a first, retracted position (e.g., home position). Additionally, FIG. 6 illustrates the first preformed article 20 positioned along (e.g., slidably nested along) the alignment members of the alignment regions 74, 75.

FIG. 7 illustrates the kickplate 81 shifting from a first, retracted position (e.g., a home position in which the kickplate 81 is clear of the light curtain generated by the first kickplate sensor 82a and the second kickplate sensor 82b) to a second, extended position. As discussed herein, the kickplate 81 may be triggered to shift from the first, retracted position to the second, extended position by the first preformed article 20 passing through the light curtain generated by the first kickplate sensor 82a and the second kickplate sensor 82b. When the light beam of the light curtain is broken by the first preformed article 20, the kickplate sensors 82a, 82b may send a signal to a kickplate actuator 83 which, in response, may shift the kickplate 81 from the first, retracted position to the second, extended position.

Further, as illustrated in FIG. 7, upon shifting from the first, retracted position to the second, extended position, the kickplate 81 may engage a first end of the first preformed article, thereby positioning the first preformed article 20 in a final longitudinal alignment position along the base 40. After engaging the preformed article 20 to position it in a final longitudinal alignment position, the one or more kickplate sensors 82a, 82b may be adapted to signal the kickplate 81 to retract to a home position. Upon receiving a signal from the one or more kickplate sensors 82a, 82b, the kickplate 81 may extend to engage one or more preformed articles and then retract into the kickplate assembly 80. In this and other examples, the linear range of motion of the kickplate 81 (i.e. distance from full retraction to full extension) may be at least five inches, at least 10 inches, at least 15 inches, at least 20 inches, at least 25 inches, at least 30 inches, at least 35 inches, at least 45 inches, at least 60 inches, at least 75 inches, at least 90 inches, or at least 100 inches or more.

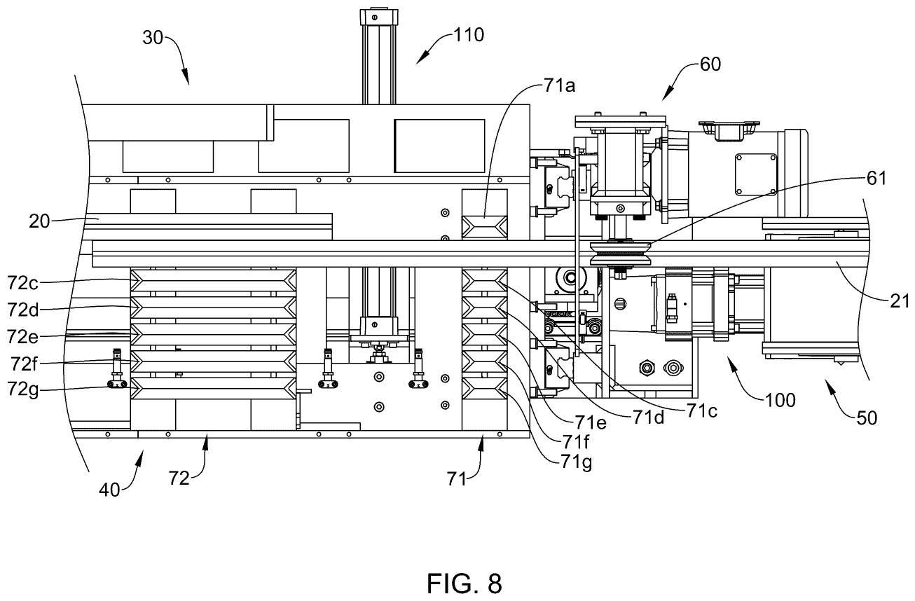

FIG. 8 illustrates a top view of the drive assembly 60 and a portion of the sorting assembly 30. FIG. 8 further illustrates the first preformed article 20 positioned after having been positioned in its final alignment position as described herein with respect to FIG. 7. FIG. 8 illustrates the first preformed article 20 positioned along the alignment member 72a (see FIG. 4) of the alignment region 72.

In this and other examples, the drive assembly 60 may include at least an upper wheel 61 adapted to receive and transport preformed article 20. FIG. 8 further illustrates the example vertical alignment motor 100, which may be affixed beneath the drive assembly 60, behind the drive assembly 60, ahead of the drive assembly 60, above the drive assembly 60, laterally adjacent to the drive assembly 60, radially adjacent to the drive assembly 60, forward of the drive assembly 60, behind the drive assembly 60 or affixed to or adjacent the drive assembly 60.

The vertical alignment motor 100 of this and other examples may be any motor or plurality of motors, including but not limited to servo motors, stator motors, DC motors, brushless DC motors, AC motors, AC/DC motors, gas motors, electric motors, synchronous motors, asynchronous motors, stepper motors, induction motors, commutator motors, direct drive motors or any equivalent known in the art.

The upper wheel 61 may rotate forward, backward, and switch rotation at any time through automation, programming or user input. In other examples, multiple upper wheels and multiple lower wheels are contemplated. In further examples, only a lower wheel is contemplated. In other words, in this and other examples the drive assembly 60 may include just one wheel. In other examples, the drive assembly may include two wheels. In yet other examples, the drive assembly may include three wheels, four wheels, five wheels, six wheels, seven wheels, eight wheels, nine wheels, 10 wheels, 11 wheels or 12 or more wheels. In further examples, the drive assembly may include two upper wheels and one lower wheel, two lower wheels and one upper wheel, three upper wheels and two lower wheels, three lower wheels and two upper wheels, three upper wheels and three lower wheels, four upper wheels and three lower wheels, four lower wheels and three upper wheels, four upper wheels and four lower wheels, or any combination or permutation of the aforementioned including the additional incorporation of added upper and/or lower wheels. Further, additional wheels may be placed adjacent to the upper and/or lower wheel and/or upper wheels and/or lower wheels. In other words, a side wheel may be incorporated adjacent to one or more lower wheels, one or more upper wheels, or adjacent to both one or more upper and lower wheels. Also, a plurality of side wheels may be incorporated adjacent to one or more lower wheels, one or more upper wheels, or adjacent to both one or more upper and lower wheels.

In further examples, the drive assembly 60 may utilize equivalent components in lieu of wheels. Other equivalent components contemplated by the present disclosure include but are not limited to pneumatic actuators, electronic actuators, piezoelectric actuators, sliding members, spinning members, rotating members, revolving members, discs, finger projections, projecting members, concave members, convex members, irregularly shaped members, vacuum pumps, suction pumps, displacement pumps, or any equivalent component known in the art. These alternative components may be present singularly, or in a plurality, or in any combination or permutation known in the art.

It can be appreciated that after the first preformed article 20 is positioned in its final longitudinal alignment position, the sorting assembly 30 may shift the base 40 along its horizontal axis 120 (see FIG. 2) to subsequently position a second preformed article 21 along the base 40 in a position adjacent (e.g., next to) the first preformed article 20. FIG. 8 illustrates that the system 10 may include a horizontal alignment motor 110 configured to shift the base 40 along the horizontal axis 120. The horizontal alignment motor 110 of this and other examples may be any motor or plurality of motors, including but not limited to servo motors, stator motors, DC motors, brushless DC motors, AC motors, AC/DC motors, gas motors, electric motors, synchronous motors, asynchronous motors, stepper motors, induction motors, commutator motors, direct drive motors or any equivalent known in the art.

It can be appreciated that after the base 40 is shifted along the horizontal axis 120, the second preformed article 21 may be transported along the conveyor 50 (see FIG. 2), through the drive assembly 60 and advanced onto the alignment member 71b (see FIG. 4) and alignment member 72b (see FIG. 4). It can be further appreciated that after the second preformed alignment article 21 is positioned in its final longitudinal alignment position along the base 40, the horizontal alignment motor 110 may shift the base 40 along its horizontal axis 120 in preparation for a third preformed article to be transported along the conveyor 50 (see FIG. 2), through the drive assembly 60 (driven by the first when 61 and/or the second wheel 62 as described herein) and advanced onto the alignment member 71c and alignment member 72c. This iterative process of advancing preformed articles along the longitudinal axis 140 of the base 40 and shifting the base 40 along its horizontal axis 120 may be performed until preformed articles are positioned along each alignment member 72a-72g (e.g., seven distinct preformed articles may be positioned and aligned in a first layer along the base 40). In other words, during and upon alignment, the second preformed article 21 may be nested along the alignment member 72b which is positioned next to the alignment members 72a occupied by the first preformed article 20. Additional preformed articles may be fed through the system 10 in this same manner whereby the kickplate 81 may align the ends of all preformed articles positioned along the alignment members of the alignment regions, as described herein.

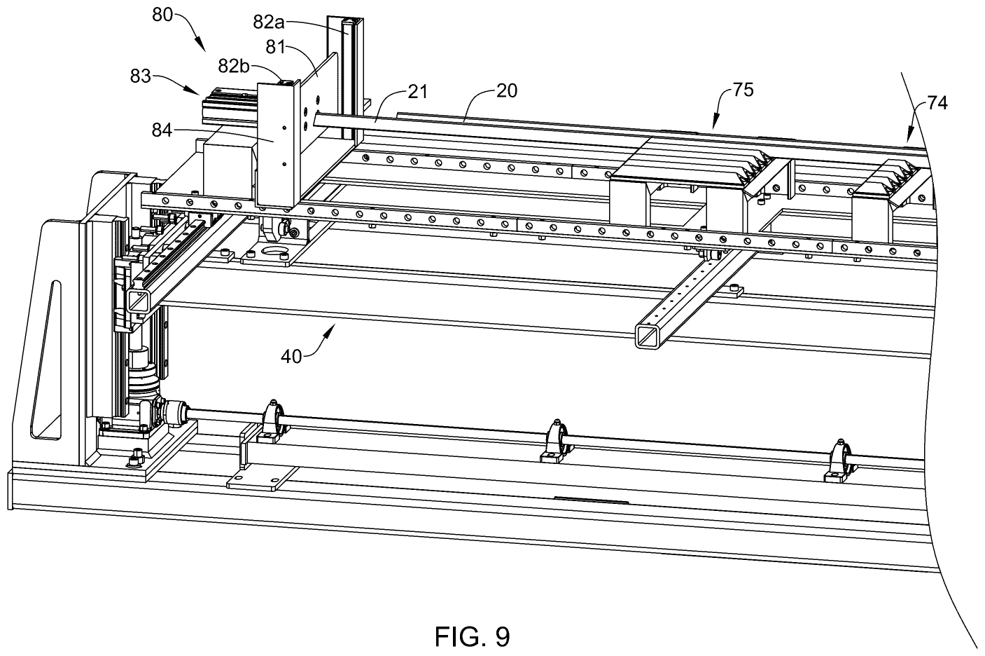

FIG. 9 illustrates the second preformed article 21 passing through the light curtain generated by the kickplate sensors 82a, 82b after having been transported along the conveyor 50, through the drive assembly 60 and onto the base 40 (as described above with respect to FIG. 8). As discussed herein, the kickplate 81 illustrated in FIG. 9 has yet to be triggered via the light curtain and remains in a retracted home position. Additionally, FIG. 9 illustrates the second preformed article 21 positioned next to the first preformed article 20 along the alignment members of the alignment regions 74, 75.

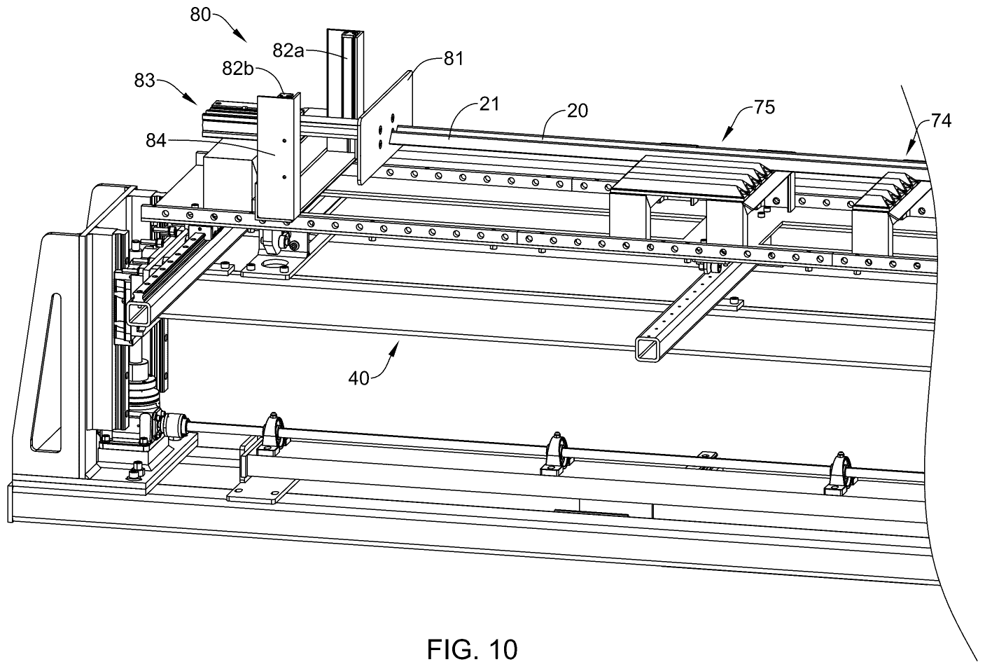

FIG. 10 illustrates the kickplate 81 shifting from a first, retracted position (e.g., a home position in which the kickplate 81 is clear of the light curtain generated by the first kickplate sensor 82a and the second kickplate sensor 82b) to a second, extended position. As discussed herein, the kickplate 81 may be triggered to shift from the first, retracted position to the second, extended position by the second preformed article 21 passing through the light curtain generated by the first kickplate sensor 82a and the second kickplate sensor 82b. When the light beam of the light curtain is broken by the second preformed article 21, the kickplate sensors 82a, 82b may send a signal to a kickplate actuator 83 which, in response, may shift the kickplate 81 from the first, retracted position to the second, extended position. The kickplate actuator 83 may be operatively connected to the kickplate assembly 80 and kickplate 81. A kickplate motor of the kickplate actuator 83 may supply power to the kickplate actuator 83, allowing the kickplate 81 to extend and retract in order to position the preformed article 20 along the base 40. Further, as illustrated in FIG. 10, upon shifting from the first, retracted position to the second, extended position, the kickplate 81 may engage a first end of the second preformed article 21, thereby positioning the second preformed article 21 in a final longitudinal alignment position along the base 40.

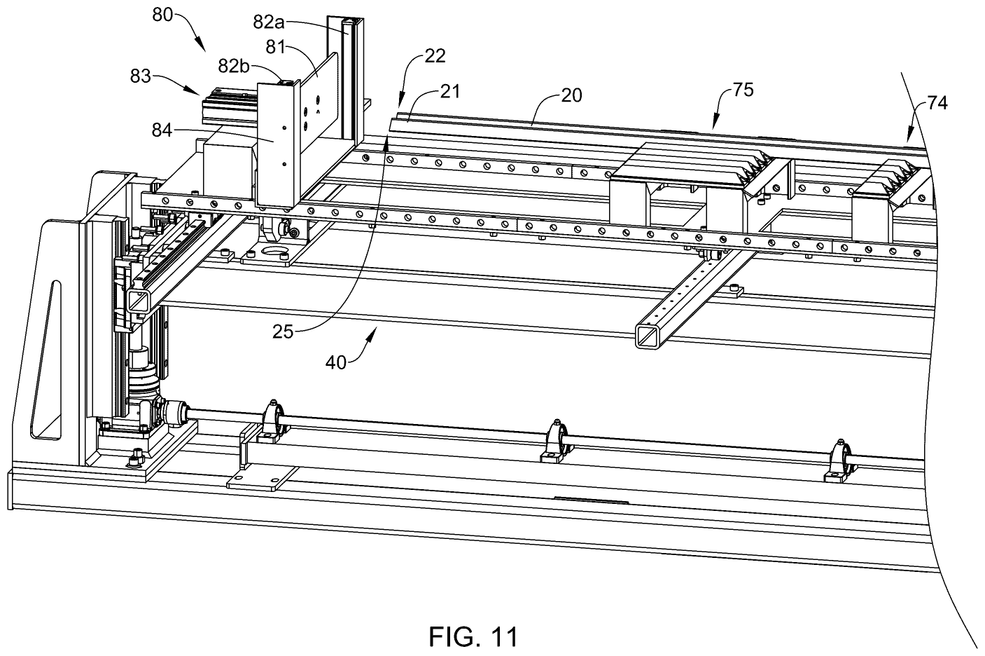

FIG. 11 illustrates the kickplate 81 shifting from the second, extended position to the first, home position. FIG. 11 further illustrates that the kickplate 81 has aligned the first end 25 of the second preformed article 21 with the first end 22 of the first preformed article 20. Additionally, when retracted to its first, home position, the kickplate 81 is clear of the light curtain generated by the kickplate sensors 82a, 82b in preparation of another preformed article to be advanced through the system 10 and be longitudinally aligned with both the first preformed article 20 and the second preformed article 21.

The kickplate 81 in conjunction with the kickplate sensor 82 may further align any amount or combination of preformed articles into a vertical array, a vertical stack, a horizontal array, a horizontal stack or any permutation or combination of the aforementioned.

Alternatively or additionally, the system 10 may include one kickplate sensor, two kickplate sensors, three kickplate sensors, four kickplate sensors, five kickplate sensors, six kickplate sensors, seven kickplate sensors, eight kickplate sensors, nine kickplate sensors, or 10 or more kickplate sensors.

Alternatively or additionally, the system 10 may include at least one kickplate sensor, at least two kickplate sensors, at least three kickplate sensors, at least four kickplate sensors, at least five kickplate sensors, at least six kickplate sensors, at least seven kickplate sensors, at least eight kickplate sensors, at least nine kickplate sensors, or at least 10 or more kickplate sensors.

Alternatively or additionally, the system 10 may include no more than one kickplate sensor, no more than two kickplate sensors, no more than three kickplate sensors, no more than four kickplate sensors, no more than five kickplate sensors, no more than six kickplate sensors, no more than seven kickplate sensors, no more than eight kickplate sensors, no more than nine kickplate sensors, no more than 10 kickplate sensors, no more than 11 kickplate sensors, no more than 12 kickplate sensors, no more than 15 kickplate sensors, no more than 20 kickplate sensors, no more than 30 kickplate sensors, no more than 40 kickplate sensors or no more than 50 kickplate sensors.

Alternatively or additionally, the linear range of motion of the kickplate 81 may be no more than five inches, no more than 10 inches, no more than 15 inches, no more than 20 inches, no more than 25 inches, no more than 30 inches, no more than 35 inches, no more than 45 inches, no more than 60 inches, no more than 75 inches, no more than 90 inches or no more than 100 inches.

Alternatively or additionally, the linear range of motion of the kickplate 81 may be about two inches, about three inches, about four inches, about five inches, about six inches, about seven inches, about eight inches, about nine inches, about 10 inches, about 12 inches, about 15 inches, about 18 inches, about 20 inches, about 25 inches, about 30 inches, about 35 inches, about 45 inches, about 60 inches, about 75 inches, about 90 inches, about 100 inches, or about 120 inches.

Alternatively or additionally, the linear range of motion of the kickplate 81 may be pre-programmed, adjusted by machine learning or artificial intelligence (AI), adjusted by user input, adjusted by GUI input, adjusted by push-button input, adjusted by a switch, adjusted by a plurality of switches or adjusted by any equivalent input or any input or plurality of inputs known in the art. Further, all components and all functions of the system 10 may be programmed, responsive to machine learning, responsive to AI, responsive to user input, responsive to GUI input, responsive to push-button input, responsive to a switch, responsive to a plurality of switches, responsive to a plurality of switches activated sequentially, responsive to a plurality of switches activated simultaneously or responsive to any equivalent input or any input or plurality of inputs known in the art.

Alternatively or additionally, the kickplate 81 may automatically retract after aligning a preformed article 20 without instruction from any or all of the kickplate sensors 82a, 82b. This action by the kickplate 81 may be programmed by a user or adjusted via machine learning/AI. The kickplate 81 may automatically retract without instruction from one or more kickplate sensors 82a, 82b any amount of distance and to any location behind the kickplate 81 and within the system 10. The kickplate 81 may return to a predefined home position in which the kickplate 81 sits at rest as shown in FIG. 5 and may extend to an alignment position or extended position such as that shown in FIG. 7. The kickplate 81 may automatically retract without instruction from any or all of the kickplate sensors 82a, 82b by about two inches, by about three inches, by about four inches, by about five inches, by about six inches, by about seven inches, by about eight inches, by about nine inches, by about 10 inches, by about 12 inches, by about 15 inches, by about 18 inches, by about 20 inches, by about 23 inches, by about 25 inches, by about 30 inches, by about 35 inches, by about 40 inches, by about 45 inches, by about 50 inches, by about 60 inches, by about 75 inches, or by about 100 inches or more. Additionally or alternatively, the kickplate 81 may automatically retract without instructions from any or all kickplate sensors 82a, 82b to a predetermined or predefined home or retraction position.

Alternatively or additionally, the kickplate 81 may automatically retract without instruction from any or all of the kickplate sensors 82a, 82b by no more than three inches, no more than five inches, no more than seven inches, no more than 10 inches, no more than 12 inches, no more than 15 inches, no more than 20 inches, no more than 25 inches, no more than 30 inches, no more than 35 inches, no more than 40 inches, no more than 45 inches, no more than 50 inches, no more than 60 inches, no more than 70 inches, no more than 75 inches, no more than 85 inches, no more than 95 inches or no more than 100 inches.

Alternatively or additionally, the kickplate 81 may automatically retract without instruction from any or all of the kickplate sensors 82a, 82b by at least one inch, at least two inches, at least three inches, at least five inches, at least 10 inches, at least 15 inches, at least 25 inches, at least 35 inches, at least 50 inches, at least 75 inches, at least 100 inches or more.

In this and other examples, the distance the kickplate 81 may extend and/or retract is up to four inches. In yet other examples, the distance the kickplate 81 may extend and/or retract is up to six inches. In further examples, the distance the kickplate 81 may extend and/or retract up to 10 inches, up to 12 inches, up to 16 inches, up to 20 inches, up to 24 inches, up to 30 inches, up to 40 inches, up to 50 inches, up to 60 inches, up to 75 inches, up to 90 inches, up to 100 inches or more.

In this and other examples, the kickplate actuator 83 may include any motor or plurality of motors including but not limited to servo motors, stator motors, DC motors, brushless DC motors, AC motors, AC/DC motors, gas motors, electric motors, solar-powered motors, synchronous motors, asynchronous motors, stepper motors, induction motors, commutator motors, direct drive motors or any equivalent known in the art. Any of the aforementioned motors may be affixed to the kickplate assembly 80, affixed adjacent the kickplate assembly 80, affixed laterally adjacent to the kickplate assembly 80, affixed radially adjacent to the kickplate assembly 80, affixed forward of the kickplate assembly 80, affixed behind the kickplate assembly 80, affixed beneath the kickplate assembly 80, or affixed above the kickplate assembly 80.

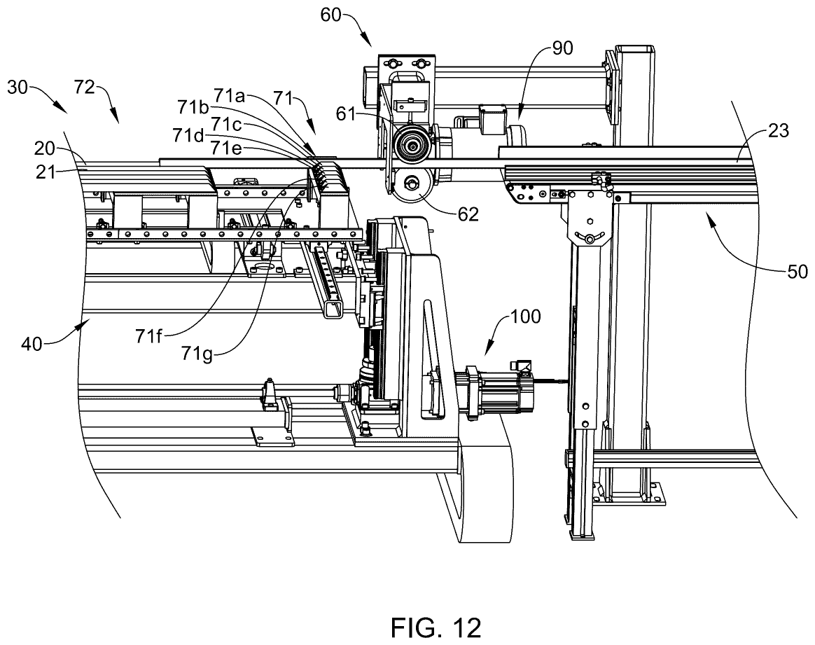

FIG. 12 illustrates a perspective view of the drive assembly 60 and a portion of the sorting assembly 30 of the system 10. As discussed herein, in some examples, the system 10 may be configured to stack multiple layers of the preformed articles on top of one another, whereby each stacked layer may be longitudinally aligned with the layer upon which it is stacked. It can be appreciated that after a first layer of preformed articles have been positioned and aligned along the base 40 (as described herein), the vertical alignment motor 100 may lower the base 40 to a position which may permit another layer of preformed articles to be stacked on top of the previously-placed layer of preformed articles. Additionally, prior to stacking the second layer of preformed articles, the horizontal alignment motor 110 (see FIG. 8) may shift (e.g., retract) the base 40 such that the wheels 61, 62 of the drive assembly 60 are aligned with the alignment member 71a. For example, FIG. 12 illustrates a third preformed article 23 being transferred from the conveyor 50, through the wheels 61, 62 of the drive assembly 60 and stacked on top of the previously-positioned performed article 20. It can be appreciated that the third preformed article 23 may be aligned with first preformed article 20 via the engagement with the kickplate 81 according to the process described herein with respect to FIGS. 6-11. Additionally, after layering and aligning the third preformed article 23 on top of the first preformed article 20, the base 40 may shift in preparation for subsequent preformed articles to be positioned on top of the second preformed article 21. This process may iteratively cycle (as described herein) to position an entire second layer of preformed articles on top of the previously-positioned first layer of preformed articles. This process may continue indefinitely until several layers of preformed articles are sorted and aligned along the base 40 of the sorting assembly 30. In this and other examples, the vertical alignment motor 100 and the horizontal alignment motor 110 may operate simultaneously, sequentially, or in a predetermined pattern programmed into the system 10, in a predetermined pattern inputted by the user of the system 10, in an updated pattern programmed into the system 10, or in an updated pattern inputted by the user of the system 10.

In this and other examples, preformed articles may be stacked on the base 40 in various configurations. For example, the preformed articles may be stacked in an aligned horizontal array of two or more preformed articles. In yet other examples, the preformed articles may be stacked in an aligned horizontal array of three or more preformed articles. In further examples, the preformed articles may be stacked in an aligned horizontal array of four or more preformed articles, five or more preformed articles, six or more preformed articles, seven or more preformed articles, eight or more preformed articles, nine or more preformed articles or 10 or more preformed articles.

In this and other examples, preformed articles may be stacked in an aligned vertical array on the base 40. For example, the preformed articles may be stacked in an aligned vertical array of two or more preformed articles. In further examples, the preformed articles may be stacked in an aligned vertical array of three or more preformed articles, four or more four or more preformed articles, five or more preformed articles, six or more preformed articles, seven or more preformed articles, eight or more preformed articles, nine or more preformed articles or 10 or more preformed articles.

In yet other examples, preformed articles may be stacked in both an aligned vertical array and an aligned horizontal array. For example, the preformed articles may be stacked in an aligned vertical array of two or more preformed articles and in an aligned horizontal array of two or more preformed articles. In further examples, the preformed articles may be stacked in an aligned vertical array of three or more preformed articles and in an aligned horizontal array of three or more preformed articles. In yet other examples, the preformed articles may be stacked in an aligned vertical array of four or more preformed articles while also aligned in a horizontal array of four or more preformed articles. Further, the preformed articles may be stacked in an aligned vertical array of five or more, six or more, seven or more, eight or more, nine or more or ten or more preformed articles while also stacked in a horizontal array of five or more, six or more, seven or more, eight or more, nine or more or ten or more preformed articles.

In further examples, more than 20 preformed articles may be nested and stacked on the alignment regions 71, 72, 73, 74, 75. In other examples, more than 50 preformed articles may be nested and stacked on the alignment regions 71, 72, 73, 74, 75. In yet further examples, more than 100 preformed articles may be nested and stacked on the alignment regions 71, 72, 73, 74, 75. In yet additional examples, more than 500 preformed articles may be nested and stacked on the alignment regions 71, 72, 73, 74, 75. In yet other examples, the preformed articles may comprise two different types of preformed articles. In other words, a set of aluminum preformed articles and steel preformed articles may be sorted an aligned on alignment regions 71, 72, 73, 74, 75 during the same operating period. Any permutation and combination of materials, preformed article amounts, and preformed article stacking arrays are also contemplated by the present disclosure.

A variety of functional technologies may be incorporated into any example of system 10 and may interface with any and all components of system 10 of the present disclosure. The variety of functional technologies include, but are not limited to: graphical user interfaces (GUIs), artificial intelligence (AI) interfaces, programs, systems, coding and devices, touch-screen interfaces, fault sensors, fault detectors, visual monitors, accelerometers, gyroscopes, oscilloscopes, inputs, outputs, input/output assemblies (I/O), software, hardware, processing logic, computer readable media, computer servers, wireless servers, wired servers, WI-FI connections, internet connections, wireless internet connections, communications ports, printers, software applications, algorithms, computer programs, HTML coding capability, computer coding capabilities, virtual reality displays (VR), augmented reality displays (AR), holographic displays, computer memory, controllers, computer operating systems, alert systems, alarm systems, visual alert systems, visual alarm systems, audio alert systems, visual alert systems or any of the equivalent or the like.

The graphical user interfaces (GUI) or any other displays contemplated by the present disclosure for incorporation with the system 10 of the present disclosure may include myriad display elements, the myriad display elements including but not limited to: preformed article position measurements, preformed article velocity measurements, preformed article acceleration measurements, preformed article jerk measurements, preformed article weight, preformed article pressure, preformed article count, preformed article batch count, remaining preformed article count, remaining preformed article batch count, alarm status, alert status, alarm modules, alert modules, motor rotation measurements, motor RPM measurements, motor function status, motor malfunction status, motor speed, motor power, motor connection status, servo motor rotation measurements, servo motor RPM measurements, servo motor function status, servo motor malfunction status, servo motor speed, servo motor power, servo motor connection status, vertical alignment motor rotation measurements, vertical alignment motor RPM measurements, vertical alignment motor function status, vertical alignment motor malfunction status, vertical alignment motor speed, vertical alignment motor power, vertical alignment motor connection status, horizontal alignment motor rotation measurements, horizontal alignment motor RPM measurements, horizontal alignment motor function status, horizontal alignment motor malfunction status, horizontal alignment motor speed, horizontal alignment motor power, horizontal alignment motor connection status, drive assembly motor rotation measurements, drive assembly motor RPM measurements, drive assembly motor function status, drive assembly motor malfunction status, drive assembly motor speed, drive assembly motor power, drive assembly motor connection status, conveyor motor rotation measurements, conveyor motor RPM measurements, conveyor motor function status, conveyor motor malfunction status, kickplate motor speed, kickplate motor power, kickplate motor connection status, kickplate motor rotation measurements, kickplate motor RPM measurements, kickplate motor function status, kickplate motor malfunction status, kickplate motor speed, kickplate motor power, kickplate motor connection status, sensor status, conveyor sensor status, drive assembly sensor status, sorting assembly sensor status, kickplate sensor status, kickplate assembly sensor status, sorting assembly position, sorting assembly base position, sorting assembly velocity, sorting assembly base velocity, sorting assembly acceleration, sorting assembly base acceleration, sorting assembly jerk, sorting assembly base jerk, sorting assembly function status, sorting assembly base function status, sorting assembly malfunction status, sorting assembly base malfunction status, preformed article capacity, conveyor capacity, drive assembly capacity, sorting assembly capacity, operation instructions, operation recommendations, operation troubleshooting, fault reset, fault status, fault alerts, fault alarms, manual override of components, automatic override of components, system on switch, system off switch, system standby switch, system pause switch, system restart switch, system recalibration switch, system calibration switch, and any of the like or equivalent.

Any known fault sensors or fault detectors may be incorporated into the system 10. The fault sensors and/or fault detectors may be adapted to detect a fault or error in any component or function of the system 10. The fault sensors and/or fault detectors may be further adapted to halt operation of system 10 when a fault or error is detected anywhere within system 10. The fault sensors and/or fault detectors may be further adapted to resume operation of system 10 by signaling to any compatible component of system 10 that a fault or error within system 10 has been resolved, obviated, overridden, or cleared.

Methods are also contemplated by the present disclosure. In an example method, a plurality of preformed articles may be sorted according to the following process: A.) transporting a first preformed article and a second preformed article via a conveyer, in which the conveyor is operatively connected to a drive assembly. B.) receiving the first preformed article and the second preformed article into the drive assembly from the conveyor. C.) transporting the first preformed article and the second preformed article, via the drive assembly, to a sorting assembly operatively connected to the drive assembly, the sorting assembly including a base, a horizontal axis and a vertical axis. D.) shifting the base along the vertical axis, the horizontal axis or along both the horizontal axis and the vertical axis to align the first preformed article with the second preformed article.

In another example, a method of sorting a plurality of preformed articles may be accomplished according to the following process: A.) transporting a first preformed article, a second preformed article and a third preformed article via a conveyer, in which the conveyor is operatively connected to a drive assembly. B.) receiving the first preformed article, the second preformed article and the third preformed article into the drive assembly from the conveyor. C.) transporting the first preformed article, the second preformed article and the third preformed article, via the drive assembly, to a sorting assembly operatively connected to the drive assembly, the sorting assembly including a base, a horizontal axis and a vertical axis. D.) shifting the base along the vertical axis, the horizontal axis or along both the horizontal axis and the vertical axis to align the first preformed article horizontally or vertically with the second preformed article, and further align horizontally or vertically with the third preformed article.

In another example, a method of sorting a plurality of preformed articles may be accomplished according to the following process: A.) transporting at least four or more preformed articles via a conveyer, in which the conveyor is operatively connected to a drive assembly. B.) receiving the four or more preformed articles sequentially into the drive assembly from the conveyor. C.) transporting the four or more preformed articles sequentially via the drive assembly, to a sorting assembly operatively connected to the drive assembly, the sorting assembly including a base, a horizontal axis and a vertical axis. D.) shifting the base along the vertical axis, the horizontal axis or along both the horizontal axis and the vertical axis to align the four or more preformed articles horizontally or vertically with the other preformed articles.

Further methods following the process detailed above are contemplated for any number of preformed articles. For instance, the methods outlined above may be applied to sorting five or more preformed articles, six or more preformed articles, 10 or more preformed articles, 15 or more preformed articles, 20 or more preformed articles, 25 or more preformed articles, 35 or more preformed articles, 50 or more preformed articles, 75 or more preformed articles, 100 or more preformed articles, 150 or more preformed articles, 200 or more preformed articles, 250 or more preformed articles, 300 or more preformed articles, 500 or more preformed articles, or 1000 or more preformed articles.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The scope of the disclosure is, of course, defined in the language in which the appended claims are expressed.

What is claimed is:

1. A system for sorting a plurality of preformed articles, the system comprising:
a sorting assembly including a base, the base having a first end region, a second end region, a horizontal axis and a vertical axis;
a conveyor configured to transport a first preformed article and a second preformed article toward the sorting assembly; and
a drive assembly positioned between the sorting assembly and the conveyor, wherein the drive assembly is configured to receive the first preformed article and the second preformed article from the conveyor and transport them from the conveyor onto the base;
wherein the sorting assembly is configured to shift the base along the horizontal axis, the vertical axis or along both the horizontal axis and the vertical axis to align the first preformed article with the second preformed article.

2. The system of claim 1, wherein the drive assembly is configured to sequentially receive the first preformed article and the second preformed article from the conveyor and transport them from the conveyor onto the base.

3. The system of claim 1, wherein the drive assembly includes a first wheel, a second wheel and a drive motor operatively coupled to the first wheel, and wherein the first wheel and the second wheel are configured to receive and transport the first preformed article and the second preformed article onto the base.

4. The system of claim 1, wherein the base includes one or more alignment regions positioned between the first end region of the base and the second end region of the base.

5. The system of claim 1, wherein the sorting assembly further includes a kickplate positioned adjacent the first end region of the base, and wherein the kickplate is configured to shift between a first retracted position and a second extended position.

6. The system of claim 1, wherein the sorting assembly further includes a first alignment motor configured to shift the base along the horizontal axis.

7. The system of claim 6, wherein the sorting assembly further includes a second alignment motor configured to shift the base along the vertical axis.

8. The system of claim 5, wherein the sorting assembly further comprises a sensor positioned adjacent the kickplate, and wherein the sensor is configured to sense the first preformed article, the second preformed article or both the first and the second preformed articles.

9. The system of claim 8, wherein the sensor is configured to signal the kickplate to shift between the first retracted position and the second extended position.

10. The system of claim 9, wherein the kickplate is configured to engage the first preformed article, the second preformed article or both the first and the second preformed articles when shifting from the first retracted position to the second extended position.

11. The system of claim 10, wherein the first preformed article includes a first end and the second preformed article includes a first end, and wherein the kickplate is configured to align the first end of the first preformed article with the first end of the second preformed article.

12. The system of claim 4, wherein the at least one or more alignment regions includes at least one or more alignment members.

13. The system of claim 12, wherein the at least one or more alignment members includes a first alignment member configured to accept the first preformed article.

14. The system of claim 12, wherein each of the one of more alignment members includes a peaked profile.

15. The system of claim 1, wherein the drive assembly further includes a sensor configured to sense a first end of the first preformed article, a second end of the first preformed article or both the first end and the second end of the first preformed article.

16. The system of claim 1, further comprising a conveyor sensor positioned adjacent the conveyor, and wherein the conveyor sensor is configured to sense a first end of the first preformed article, a second end of the first preformed article or both the first end and the second end of the first preformed article.

17. A system for sorting a plurality of preformed articles, the system comprising:
a sorting assembly including a base, the base having a first end region, a second end region, a horizontal axis and a vertical axis, and wherein the base includes one or more alignment regions positioned between the first end region of the base and the second end region of the base;
a conveyor configured to transport a first preformed article and a second preformed article toward the sorting assembly;
a drive assembly positioned between the sorting assembly and the conveyor, wherein the drive assembly is configured to receive the first preformed article and the second preformed article from the conveyor and transport them from the conveyor onto the base;
wherein the sorting assembly is configured to shift the base along the horizontal axis, the vertical axis or along both the horizontal axis and the vertical axis to align the first preformed article with the second preformed article along the one or more alignment regions.

18. The system of claim 17, wherein the one or more alignment regions include one or more alignment members and the one or more alignment regions are configured to receive and align at least the first preformed article, the second preformed article and a third preformed article of preformed material.

19. The system of claim 17, wherein the sorting assembly further includes a kickplate positioned adjacent the first end region of the base, wherein the kickplate includes a plurality of sensors and is configured to shift between a first retracted position and a second extended position.

20. A method for sorting a plurality of preformed articles, the method comprising:
transporting a first preformed article and a second preformed article via a conveyor, and wherein the conveyor is operatively connected to a drive assembly;
receiving the first preformed article and the second preformed article into the drive assembly from the conveyor;
transporting the first preformed article and the second preformed article, via the drive assembly, to a sorting assembly operatively connected to the drive assembly, and wherein the sorting assembly includes a base, a horizontal axis and a vertical axis;
shifting the base along the vertical axis, the horizontal axis or along both the horizontal axis and the vertical axis to align the first preformed article with the second preformed article.
